(19) United States
(12) Patent Application Publication
(10) Pub. No.: US 2018/0147747 A1
(43) Pub. Date: May 31, 2018

(54) TREATMENT SYSTEM FOR PLASTIC MATERIAL

(71) Applicant: Next Generation Recyclingmaschinen GmbH, Feldkirchen an der Donau (AT)

(72) Inventors: Klaus BRZEZOWSKY, Marchtrenk (AT); Klemens GRUBER, Rainbach (AT); Thomas PICHLER, St. Peter am Wimberg (AT)

(73) Assignee: Next Generation Recyclingmaschinen GmbH, Feldkirchen an der Donau (AT)

(21) Appl. No.: 15/578,836

(22) PCT Filed: Jun. 1, 2016
(86) PCT No.: PCT/AT2016/050170

§ 371 Date: Feb. 8, 2018

(30) Foreign Application Priority Data
Jun. 3, 2015 (AT) A 50451/2015

(51) Int. Cl. B29B 17/04; B02C 18/14; B02C 18/22

(52) U.S. Cl. CPC B29B 17/0412; B02C 18/148; B29K 2101/12; B02C 18/2291; B02C 18/141; B02C 18/2216

(57) ABSTRACT

A treatment system for plastic material includes a feeding device, a treatment unit, and a plasticizing device arranged downstream thereof. The treatment unit has a comminuting device and a conveying device which are received in a housing. An outlet opening is arranged in an end region of a conveying section of the conveying device. The plasticizing device has an extruder screw which is received in an extruder housing. The extruder housing is equipped with a filling opening which is arranged so as to directly adjoin the outlet opening arranged in the housing. In the region of the outlet opening, the conveying device has a circulating direction which runs in the opposite direction of the conveying direction of the extruder screw.

The invention relates to a processing plant for plastics material, in particular for the processing of thermoplastic plastics material for the recycling thereof, as this is described in claim 1.

From WO 98/16360 A, and from the therefrom derived EP 0 934 144 B1, respectively a processing device, configured according to the generic type, for the comminution, conveyance and subsequent plasticization of thermoplastic plastics material have become known. This processing device comprises a feed device, a processing unit and a following plasticizing device. The processing unit comprises, for its part, a comminuting device, a spirally configured conveying device, a tubularly configured housing, and at least one drive means for the comminuting device and for the conveying device. The comminuting device, and the spiral conveying device following the comminuting device, are accommodated, and rotatably mounted, in the tubularly configured housing. Furthermore, the conveying device defines a first conveying section having a first longitudinal axis. The tubular housing has in the region of the comminuting device at least one feed opening, which is open toward the feed device, and in an end region of the first conveying section of the conveying device a bottom-side discharge opening. The plasticizing device comprises, for its part, an extruder screw accommodated in an extender housing, and a further drive means for this same. The extruder screw has a further conveying section and defines in this a further longitudinal axis. In the extruder housing is arranged a fill opening, wherein the fill opening and the discharge opening arranged in the tubular housing are arranged directly adjoining each other. The first longitudinal axis of the conveying device and the further longitudinal axis of the extruder screw are arranged such that they intersect in the region of the discharge opening and of the fill opening, with respect to a projection onto a horizontal plane, at an angle of 90°. The direction of circulation of the processing unit is chosen such that, at the discharge opening, it coincides with the direction of conveyance of the extruder screw.

A similar processing device, configured according to the generic type, has become known from EP 1 918 084 B1, which is focused on the geometric configuration of the transfer region between the conveying device and the extruder screw. Here too, the first longitudinal axis of the conveying device and the further longitudinal axis of the extruder screw are once again arranged such that they intersect in the transfer region between the discharge opening and the fill opening, with respect to a projection onto a horizontal plane, at an angle of 90°, or at an angle to each other which differs therefrom. The direction of circulation of the processing unit is chosen such that, at the discharge opening, it coincides with the direction of conveyance of the extruder screw.

These two known processing devices have proved themselves very well in practice, though not in all operating situations was a uniform transfer of the comminuted plastics material to the plasticizing device able to be achieved. In individual cases, in the transfer region of the comminuted plastics material between the discharge opening from the region of the conveying device and the fill opening into the plasticizing device, items of plastic were able to accumulate, thereby resulting in a diminution of the openings, right up to a blockage of these same.

The object of the present invention is to make the transfer of the comminuted plastics material from the conveying device to the plasticizing device more uniform and still more constant, in order thus to obtain a, during operation, more uniform degree of filling of the extruder screw of the plasticizing device.

This object of the invention is achieved by virtue of the fact that the spirally configured conveying device, in the region of the discharge opening from the housing, has a direction of circulation which, with respect to the direction of conveyance of the at least one extruder screw, runs in a direction opposite thereto.

The resultant advantage lies in the fact that hence, in the transfer region of the comminuted plastics material from the conveying device to the extruder screw, no stuffing-in can occur. As a result of the motional sequences, chosen in the opposite direction or in the reverse direction, between the mutually intersecting conveying sections of the conveying device and of the extruder screw, in the end region of the conveying section, either by the spiral conveyor helix and/or by additional extensions projecting over the central shaft body, the plastics items no longer received by the conveyor screw can thus be scraped off and conveyed into a following free space of the extruder screw. An overfilling of the extruder screw, and an accompanying blockage of this same, can hence be better and more easily prevented. In this way, a more uniform and more secure evacuation of the plastics items which are to be received in the extruder screw and are subsequently to be melted can be created in this transfer region.

Another embodiment is distinguished by the fact that the comminuting device and the conveying device are arranged or configured on a common processing drum. It is hence possible to make do with a single drive motor. Moreover, the mounting of the comminuting device and of the conveying device can in this way, however, also be made simpler and more cost-effective.

A further configuration provides that, with respect to a projection onto a horizontal plane, an angle formed between the first longitudinal axis of the first conveying section of the conveying device and the further longitudinal axis of the further conveying section of the extruder screw is chosen equal to a right angle. Hence a space-saving mutual arrangement between the processing unit and the plasticizing device is created. Moreover, a uniform transfer operation of the plastics material can furthermore in this way also be obtained, however, irrespective of the pitch direction of the two conveying sections.

Furthermore, it is advantageous, if, with respect to a projection onto a horizontal plane, an angle formed between the first longitudinal axis of the first conveying section of the conveying device and the further longitudinal axis of the further conveying section of the extruder screw is chosen unequal to a right angle. As a result of the deviation of the mutual orientation of the two longitudinal axes from the right angle, regard can thus easily be paid to different plant arrangements one to another. Moreover, in dependence on the respectively chosen pitch direction, a still more uniform and more constant transfer of the plastics items can thus be obtained.

Another embodiment is distinguished by the fact that, with respect to a projection onto a horizontal plane, an angle formed between the first longitudinal axis of the first conveying section of the conveying device and the further longitudinal axis of the further conveying section of the extruder screw is an acute angle. Hence the spatial requirement for the processing plant can be kept still smaller. Moreover, also in dependence on the pitch direction of the two conveying sections, the extent of the transfer volume of plastics items, can hence, however, be determined.

A further possible embodiment has the features that, with respect to a projection onto a horizontal plane, an angle formed between the first longitudinal axis of the first conveying section of the conveying device and the further longitudinal axis of the further conveying section of the extruder screw is an obtuse angle. It thereby becomes possible to be more easily able to connect to plant components which follow on from the plasticizing device. Subsequently, a more flexible arrangement and installation of the processing plant in relation to the other system components can hence be realized.

A further configuration provides that the first longitudinal axis in the region of the first conveying section of the conveying device and the further longitudinal axis in the region of the further conveying section of the at least one extruder screw are respectively arranged running in a horizontal plane. As a result of the mutually parallel arrangement of the two conveying sections of conveying device and extruder screw one to the other, a simple and more cost-effective manufacture, and a constant, uniform onward transport of the comminuted items of plastics material, can thus be obtained.

Another embodiment is distinguished by the fact that the first longitudinal axis in the region of the first conveying section of the conveying device, viewed in its direction of conveyance, is oriented such that it slopes down toward at least one extruder screw of the plasticizing device. As a result of the conveying device arranged sloping down at an angle, a better conveying effect toward the plasticizing device can thus be obtained. Furthermore, also relatively small and very small plastics particles, which can generally be deposited in the bottom region of the housing, are likewise more easily transported toward the plasticizing device.

A further preferred embodiment is characterized in that the spirally configured conveying device has a right-hand pitch and the at least one extruder screw likewise a right-hand pitch, and both the conveying device and the extruder screw, respectively viewed in the direction of conveyance thereof, are driven counterclockwise. Hence, in dependence on the, with respect to the direction of conveyance, thereto oppositely running direction of circulation of the conveying device, the orientation of the plasticizing device for the appropriate installation can be more easily determined.

Furthermore, it is advantageous if the spirally configured conveying device has a left-hand pitch and the at least one extruder screw likewise a left-hand pitch, and both the conveying device and the extruder screw, respectively viewed in the direction of conveyance thereof, are driven clockwise. As a result, also where left-hand pitch directions are used and the opposite direction of circulation with respect to the direction of conveyance is maintained, an oppositely directed orientation with respect to the installation of the plasticizing device can be obtained.

Another embodiment is distinguished by the fact that the spirally configured conveying device has a right-hand pitch and the at least one extruder screw a left-hand pitch, and the conveying device, viewed in its direction of conveyance, is driven counterclockwise, and the extruder screw, viewed in its direction of conveyance, clockwise, or that the spirally configured conveying device has a left-hand pitch and the at least one extruder screw a right-hand pitch, and the conveying device, viewed in its direction of conveyance, is driven clockwise, and the extruder screw, viewed in its direction of conveyance, counterclockwise. Even where mutually differently pitch directions of the two conveying sections are chosen and the sense of circulation is chosen correspondingly, the opposite direction of circulation with respect to the direction of conveyance of the extruder screw can always be observed, given a different direction of extent of the plasticizing device.

For a better understanding of the invention, this is explained in greater detail with reference to the following figures, in which, respectively in heavily simplified, schematic representation:

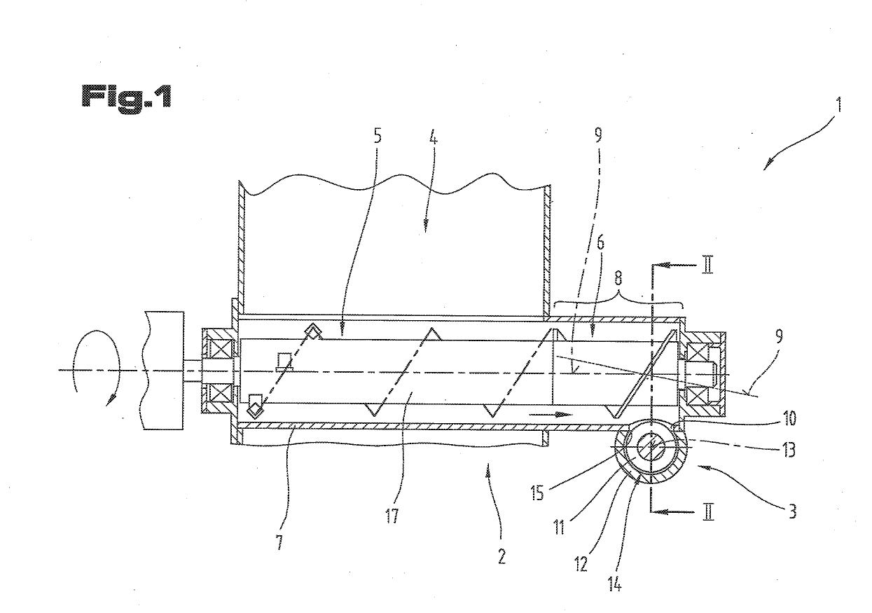

FIG. 1 shows a partial detail of a processing plant in an axial vertical section through the processing unit;

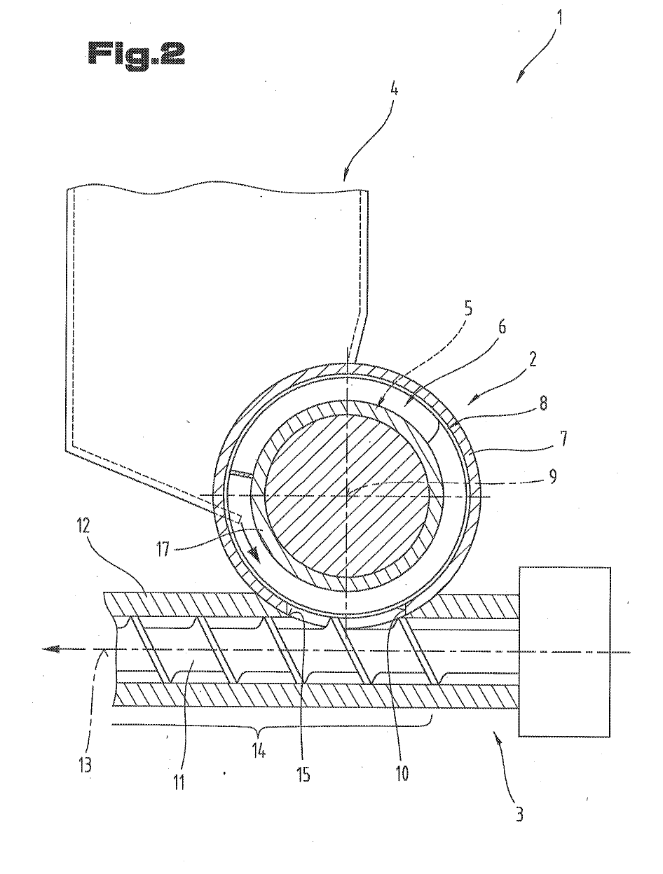

FIG. 2 shows a radial section through the conveying device of the processing unit in the transfer region to the extruder screw of the plasticizing device, along the lines II-II in FIG. 1;

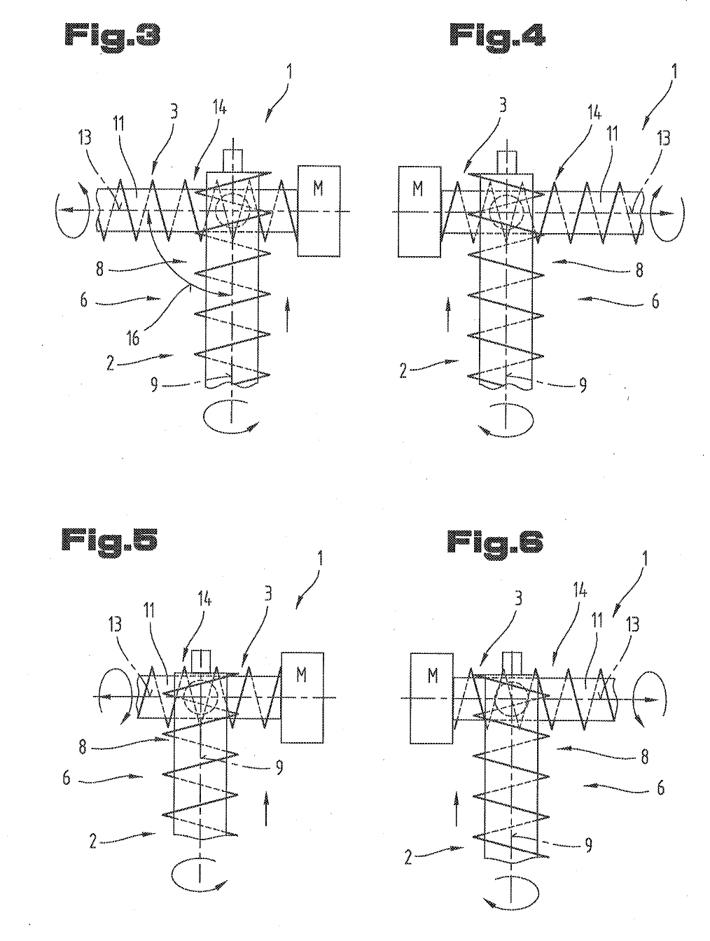

FIG. 3 shows a schematic diagram of a possible first arrangement and configuration of the conveying device and of the extruder screw, in top view;

FIG. 4 shows a further schematic diagram of a possible second arrangement and configuration of the conveying device and of the extruder screw, in top view;

FIG. 5 shows another schematic diagram of a possible third arrangement and configuration of the conveying device and of the extruder screw, in top view;

FIG. 6 shows a further schematic diagram of a possible fourth arrangement and configuration of the conveying device and of the extruder screw, in top view;

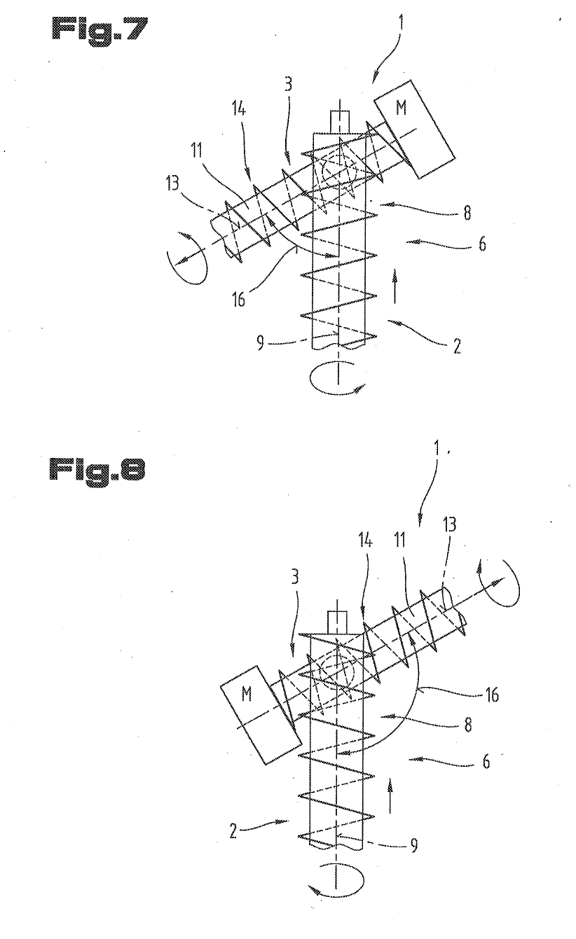

FIG. 7 shows a schematic diagram of an arrangement of the conveying device and of the extruder screw, which arrangement forms an acute angle, in top view;

FIG. 8 shows a schematic diagram of an arrangement of the conveying device and of the extruder screw, which arrangement forms an obtuse angle, in top view.

By way of introduction, it should be noted that, in the differently described embodiments, same parts are provided with same reference symbols or same component designations, wherein the disclosures contained in the overall description can be analogously transferred to same parts having same reference symbols or same component designations. Also the positional specifications chosen in the description, such as, for example, at the top, at the bottom, on the side, etc. are related to the directly described and represented figure, and these positional specifications, in the event of a change of position, can be analogously transferred to the new position.

The term “in particular” is hereinafter understood such that it relates to a possible more specific configuration or more detailed specification of an object or of a method step, but does not necessarily have to constitute a compulsory, preferred embodiment of the same, or a procedure.

In FIGS. 1 and 2, a processing plant 1 for plastics material, in particular for the processing of thermoplastic plastics material for the recycling thereof, is shown in simplified representation and only in part-sections. The processing plant 1 is generally installed on a flat, preferredly horizontally oriented standing surface, such as, for example, a shop floor.

In principle, a processing plant 1 of this type serves firstly to comminute the generally relatively large-volume plastics material to an appropriate fragment size in a processing unit 2 to form, in terms of its size, further processable items, and subsequently to melt these in a plasticizing device 3. The plastics material to be comminuted can be formed by relatively large items in a wide variety of dimensions and sizes, sheets, or else also already precomminuted part-items. The melt stream melted by the plasticizing device 3 and issuing therefrom, or the issuing melt streams, can either be cooled after their shaping and be granulated for subsequent treatment, or fed to a directly following further processing facility, and/or corresponding shaping facility. The directly following shaping can be realized in an extrusion process or an injection molding process, in which case nor does the heat quantity contained in the melt have firstly to be removed and subsequently returned.

Upstream of the processing unit 2 is generally arranged a feed device 4, which in a known manner serves to collect the plastics material to be treated and/or to be processed, and to conduct it to the processing unit 2. The feed can here be realized automatically by virtue of the own weight, and/or by means of an additional feed device, which moves the not yet comminuted plastics material toward the processing unit 2. Generally, a feed shaft is used for the reception and forwarding to the processing unit 2.

The processing unit 2 can comprise a comminuting device 5 and a conveying device 6, which are accommodated, and rotatably mounted, in a preferredly tubularly configured housing 7. The generally rotary drive can be realized with at least one drive means (not specifically denoted). The conveying device 6 serves to convey the previously comminuted plastics material in the longitudinal direction onward to a transfer region (subsequently described in greater detail). Viewed in the direction of conveyance, the preferredly spirally configured conveying device 6 is arranged downstream of the comminuting device 5. Furthermore, the conveying device 6 forms a first conveying section 8 and also defines a first longitudinal axis 9. In the region of the first conveying section 8, the direction of conveyance is illustrated with an arrow. Generally, the conveying device 6 is formed by a central shaft body, on the outer periphery of which is arranged or configured at least one spirally or helically configured, convolute flight. The shaft body can, for its part, also be of tubular configuration and be supported inside it on a bearing shaft, and/or rotatably mounted thereon.

The configuration of the processing unit 2 with its comminuting device 5, and with its conveying device 6, can be chosen, for example, such as is more closely described in EP 0 934 144 B1. Therefore, allusion and reference is here made to this description, in order to avoid necessary repetitions.

The, in this illustrative embodiment, preferredly spirally or helically configured flight can either be configured continuously over the longitudinal extent and/or interruptedly over the longitudinal extent. This flight does not necessarily have to be arranged to right up to the end of the conveying device 6, but rather it can also end shortly before this end. In this case, own extensions, which are configured such that they project one above another in the radial direction and are distributed over the periphery, can also be provided on the central shaft body. These extensions can also be of blade-like configuration.

The clear cross section of the tubularly configured housing 7 is preferredly configured as a circular area. In the region of the comminuting device 5, at least one feed opening which is open toward the feed device 4 can also be arranged or configured in the housing 7, through which feed opening the plastics material makes its way toward the comminuting device 5.

For the transfer of the comminuted plastics material from the processing unit 2, in particular of the conveying device 6, toward the plasticizing device 3, in an end region of the first conveying section 8 of the conveying device 6 is provided at least one discharge opening 10. In this illustrative embodiment, the at least one discharge opening 10 is arranged in the bottom side of the housing 7. It would also be possible, however, to arrange the discharge opening 10 at the front end of the conveying device 6 in the housing 7. The discharge opening 10 could also be arranged above and/or on the side of the conveying device 6 in the housing 7. The respective position or arrangement of the at least one discharge opening 10 can be chosen in dependence on the arrangement of the downstream plasticizing device 3.

The plasticizing device 3 can have at least one extruder screw 11, which can be received and mounted in an extruder housing 12 and, by means of a further drive means (likewise not specifically denoted), can be set in a rotary motion about a further longitudinal axis 13.

The at least one extruder screw 11 defines, for its part, the further longitudinal axis 13, and a further conveying section 14. For the take-up of the comminuted plastics material, in the extruder housing 12 is provided at least one fill opening 15. In this illustrative embodiment which is shown here, the discharge opening 10 arranged in the tubular housing 7 and the fill opening 15 arranged in the extruder housing 12 are arranged directly adjoining each other and jointly form a connection opening. Since the discharge opening 10 is arranged on the bottom side and the plasticizing device 3, with its extruder screw 11, is arranged beneath the housing 7, the two openings 10, 15 are located one above the other and in a preferredly mutually overlapping position. It is of fundamental importance that the two openings 10, 15 are fluidically connected to each other for the transfer and forwarding of the comminuted plastics material. This transfer should preferredly be formed such that it is leak-tight.

It would also be possible, however, for the at least one discharge opening 10 and the at least one fill opening 15 to be fluidically connected to each other via one or more connecting pieces (not represented in detail), and thus do not necessarily have to be directly adjoining.

The connecting piece or pieces could be formed, for example, by tubes having very varied cross sections and/or longitudinal extent. Thus, the fill opening 15 can be distanced, and thus spaced apart, from the discharge opening 10.

Due to the arrangement of the conveying device 6 and the extruder screw 11 one above the other, offset from one another in the vertical direction, the mutual relative position and longitudinal extent of the two longitudinal axes 9, 13 is related to a projection of the same onto a horizontal plane when viewed from above—thus in top view. As a horizontal plane is regarded an imaginary (though not represented in detail) plane. In the present illustrative embodiment, the two longitudinal axes 9, 13 are arranged such that they intersect in the region of the discharge opening 10 and the fill opening 15. Thus, in one possible configuration, an angle 16 formed, with respect to a projection onto the horizontal plane, between the first longitudinal axis 9 of the first conveying section 8 of the conveying device 6 and the further longitudinal axis 13 of the further conveying section 14 of the extruder screw 11 can amount to, for example, 90°. Hence, the two longitudinal axes 9, 13 are oriented running at a right angle to each other. Further therefrom independent and, where appropriate, self-contained arrangement possibilities with respect to the longitudinal orientation of the two longitudinal axes 9, 13 one to the other are further described below.

In processing plants 1 of this type, generally the comminuting device 5 and the conveying device 6 are arranged or configured on a common processing drum 17. Thus, it is possible to make do with a single and common drive means for both devices.

Viewed in the direction of the first longitudinal axis 9, the comminuting device 5 can have, in a preferredly helical arrangement along the outer periphery of the processing drum 17, a plurality of blades protruding therefrom in the radial direction, which blades, in a known manner, are in intermeshing engagement with a preferredly continuous counter-blade.

Furthermore, it is here also provided that the preferredly spirally configured conveying device 6, in the region of the discharge opening 10 from the tubular housing 7, has a direction of circulation which, with respect to the direction of conveyance of the at least one extruder screw 11, runs in a direction opposite thereto. As a result of the mutually opposite rotational movement of the preferredly spirally configured conveying device 6 and of the direction of conveyance of the extruder screw 11, in the transfer region a “stuffing”, and thus an overfilling, of the extruder screw 11 can be better prevented. Furthermore, a more uniform degree of filling of the extruder screw 11 can hereby, however, also be achieved.

In FIGS. 3 to 6, in dependence on the respective pitch direction of the here spirally configured conveying device 6 and of the extruder screw 11, respectively the individual directions of conveyance and directions of circulation are shown in simplified and schematic representation. Furthermore, from these schematic representations it can further be seen that, with respect to a projection onto the horizontal plane, the angle 16 formed between the first longitudinal axis 9 of the first conveying section 8 of the conveying device 6 and the further longitudinal axis 13 of the further conveying section 14 of the extruder screw 11 is respectively chosen equal to a right angle, and thus of 90°. All the hereinafter described different configurations and arrangements can respectively be used in isolation in connection with the processing plant 1 previously described in detail. The rotational directions or the directions of circulation are always specified whenever the respective conveying section 8, 14 is viewed in the direction of a direction of conveyance.

In FIG. 3, a first and, where appropriate, mutually self-contained arrangement of the conveying device 6 and the extruder screw 11 is shown. The spirally configured conveying device 6, as well as the at least one extruder screw 11, here respectively has a right-hand pitch. In order to obtain that direction of circulation of the conveying device 6 which is opposite to the direction of conveyance of the extruder screw 11, both the conveying device 6 and the extruder screw 11 are or can be driven counterclockwise.

In FIG. 4, a second and, where appropriate, mutually self-contained arrangement of conveying device 6 and extruder screw 11 is shown. Here, the spirally configured conveying device 6, as well as the at least one extruder screw 11, respectively has a left-hand pitch direction. In order to obtain that direction of circulation of the conveying device 6 which is opposite to the direction of conveyance of the extruder screw 11, both the conveying device 6 and the extruder screw 11 are or can be driven clockwise.

In FIG. 5, a third and, where appropriate, mutually self-contained arrangement of conveying device 6 and extruder screw 11 is shown. The spirally configured conveying device 6 here has a right-hand pitch, and the at least one extruder screw 11 a left-hand pitch. In order, here too, to once again obtain the mutually oppositely running movements, the conveying device 6, viewed in its direction of conveyance, is or can be driven counterclockwise, and the extruder screw 11, viewed in its direction of conveyance, is or can be driven clockwise.

Furthermore, in FIG. 6, a fourth and, where appropriate, mutually self-contained arrangement of conveying device 6 and extruder screw 11 is shown. The spirally configured conveying device 6 here has a left-hand pitch, and the at least one extruder screw 11 a right-hand pitch.

The direction of circulation of the conveying device 6 is here, viewed in its direction of conveyance, chosen clockwise, wherein the direction of circulation of the extruder screw 11, viewed in its direction of conveyance, is chosen counterclockwise.

In FIGS. 7 and 8, it is further shown that a mutual orientation of the two longitudinal axes 9, 13 which is different from that previously in FIGS. 3 to 6 is still possible. With respect to a projection onto the horizontal plane, the angle 16 formed between the first longitudinal axis 9 of the first conveying section 8 of the conveying device 6 and the further longitudinal axis 13 of the further conveying section 14 of the extruder screw 11 is here chosen unequal to a right angle. These arrangement possibilities which are here described can be intercombined in an appropriate manner, according to choice, with all the previously described configurations. As a result of the non-right-angled longitudinal orientation of the two longitudinal axes 9, 13 one to the other, in dependence on the respective pitch angle and the pitch direction of the screw thread, or of the thread teeth of the conveying device 6 and of the extruder screw 11, the orientation and the relative position of the screw flights one to another in the region of the point of intersection can be determined.

In FIG. 7 is shown that, in the case of a projection onto the horizontal plane, the angle 16 formed between the first longitudinal axis 9 of the first conveying section 8 of the conveying device 6 and the further longitudinal axis of the further conveying section 14 of the extruder screw 11 is an acute angle. The acute angle is preferredly selected within a range whereof the lower value is, for example, 5° to 10°, and whereof the upper value is, for example, 70° to 85°. Preferredly, values of the angle 16 can be chosen within a range between 30° and 60°.

In contrast thereto, in FIG. 8 is shown that, given the same direction of projection, the angle 16 between the two longitudinal axes 9, 13 in the region of the two conveying sections 8, 14 is an obtuse angle, and thus has a value of greater than 90°. The obtuse angle is preferredly selected within a range whereof the lower value is, for example, 95° to 110°, and whereof the upper value is, for example, 160° to 175°. Preferredly, values of the angle 16 are chosen within a range between 120° and 150°.

The previously specified lower and upper limit values of the acute angle 16 can also be chosen still less than 5°, or greater than 85°. The obtuse angle 16 can also have a lower limit value less than 95° or an upper limit value greater than 175°.

A preferred embodiment provides that, in the region of intersection between the two conveying sections 8, 14, the two longitudinal axes 9, 13 are oriented at such an angle to each other that the pitch angle of the screw thread or of the thread teeth of the conveying device 6 runs parallel with respect to the screw thread or to the thread teeth of the extruder screw 11. Hence, in the transfer region between the conveying device 6 and the extruder screw 11 of the plasticizing device 3, an additional shearing effect on the comminuted plastics material can thus be reduced or totally avoided.

Preferredly, the first longitudinal axis 9 in the region of the first conveying section 8 of the conveying device 6 and the further longitudinal axis 13 in the region of the further conveying section 14 of the at least one extruder screw 11 are respectively arranged running in a horizontal plane. The two horizontal planes are oriented such that they are spaced apart in the vertical direction and also run parallel to each other. The vertical distance between the two horizontal planes can have any chosen finite value, starting from the value 0 (zero). This distance value is dependent on the dimensions of the conveying device 6 and the plasticizing device 3, and their spatial arrangement one to the other.

Irrespective of this, it would also be possible, however, as indicated in FIG. 1 by a dashed line, that, for example, the longitudinal axis 13 of the extruder screw 11 is oriented running in the horizontal plane, yet the first longitudinal axis 9 at least of the conveying device 6 in the region of the first conveying section 8, viewed in its direction of conveyance, is oriented such that it slopes down toward the at least one extruder screw 11. To a small extent, the conveying movement of the comminuted plastics material can hence be made easier.

The two longitudinal axes 9, 13 can also be designated as rotational axes for these components. The conveying device 6, with its outer envelope in the region of its conveying screw or its conveying members, is preferredly arranged at a short distance from the outer envelope of the extruder screw 11.

The illustrative embodiments show possible design variants of the processing plant 1, wherein at this point it should be noted that the invention is not limited to the specifically represented design variants of these same, but rather various mutual combinations of the individual design variants are also possible, and this variation option, based on the technical teaching by the present invention, lies within the ability of the person skilled in the art who is engaged in this technical field.

Furthermore, individual features or feature combinations from the different illustrative embodiments which are shown and described can also constitute independent inventive solutions or solutions according to the invention.

The object underlying the independent inventive solutions can be derived from the description.

All specifications relating to value ranges in the present description should be understood such that these jointly embrace any and all sub-ranges therefrom, for example the specification 1 to 10 should be understood such that all sub-ranges, starting from the lower limit 1 and the upper limit 10, are jointly covered, i.e. all sub-ranges begin with a lower limit of 1 or more and end at an upper limit of 10 or less, for example 1 to 1.7, or 3.2 to 8.1, or 5.5 to 10.

Above all, the individual embodiments shown in FIG. 1, 2; 3; 4; 5; 6; 7; 8 form the subject of independent solutions according to the invention. The relevant objects and solutions according to the invention can be derived from the detailed descriptions of these figures.

For the record, it should be pointed out, by way of conclusion, that for a better understanding of the structure of the processing plant 1, this, or the components thereof, have in part been represented such that they are not true to scale and/or are enlarged and/or reduced in size.

### REFERENCE SYMBOL LIST

1 processing plant
2 processing unit
3 plasticizing device
4 feed device
5 comminuting device
6 conveying device
7 housing
8 first conveying section
9 first longitudinal axis
10 discharge opening
11 extruder screw
12 extruder housing
13 further longitudinal axis
14 further conveying section
15 fill opening
16 angle
17 processing drum

1-12. (canceled)

13. A processing plant (1) for plastics material, in particular for the processing of thermoplastic plastics material for the recycling thereof, comprising
a feed device (4),
a processing unit (2) having a comminuting device (5), a preferredly spirally configured conveying device (6), a tubularly configured housing (7), and having at least one drive means for the comminuting device (5) and for the conveying device (6),
whereby the comminuting device (5) and the conveying device (6) adjoining the comminuting device (5) in the direction of conveyance are accommodated in the axial direction, and rotatably mounted, in the tubularly configured housing (7), and
whereby the conveying device (6) defines a first conveying section (8) having a first longitudinal axis (9), and
whereby the housing (7) has, in the region of the comminuting device (5), at least one feed opening open toward the feed device (4) and, in an end region of the conveying section (8) of the conveying device (6), a discharge opening (10),
a plasticizing device (3) having at least one extruder screw (11), accommodated in an extruder housing (12), and a further drive means for the at least one extruder screw (11), and the at least one extruder screw (11) defines a further longitudinal axis (13) and a further conveying section (14),
whereby, viewed in the direction of conveyance, the plasticizing device (3) is arranged downstream of the processing unit (2), and
whereby a fill opening (15) is arranged in the extruder housing (12), and the fill opening (15) and the discharge opening (10) arranged in the housing (7) are arranged directly adjoining each other, form a common connecting opening and are fluidically connected to each other, and
whereby, with respect to a projection onto a horizontal plane, the first conveying section (8) of the conveying device (6), with its first longitudinal axis (9), and the further conveying section (14) of the at least one extruder screw (11), with its further longitudinal axis (13), are oriented such that they intersect in the region of the discharge opening (10) and the fill opening (15),
wherein the preferredly spirally configured conveying device (6) has, in the region of the discharge opening (10) from the housing (7), a direction of circulation which runs, with respect to the direction of conveyance of the at least one extruder screw (11), in the direction opposite thereto.

14. The processing plant (1) as claimed in claim 13, wherein the comminuting device (5) and the conveying device (6) are arranged or configured on a common processing drum (17).

15. The processing plant (1) as claimed in claim 13, wherein, with respect to a projection onto a horizontal plane, an angle (16) formed between the first longitudinal axis (9) of the first conveying section (8) of the conveying device (6) and the further longitudinal axis (13) of the further conveying section (14) of the extruder screw (11) is chosen equal to a right angle.

16. The processing plant (1) as claimed in claim 13, wherein, with respect to a projection onto a horizontal plane, an angle (16) formed between the first longitudinal axis (9) of the first conveying section (8) of the conveying device (6) and the further longitudinal axis (13) of the further conveying section (14) of the extruder screw (11) is chosen unequal to a right angle.

17. The processing plant (1) as claimed in claim 13, wherein, with respect to a projection onto a horizontal plane, an angle (16) formed between the first longitudinal axis (9) of the first conveying section (8) of the conveying device (6) and the further longitudinal axis (13) of the further conveying section (14) of the extruder screw (11) is an acute angle.

18. The processing plant (1) as claimed in claim 13, wherein, with respect to a projection onto a horizontal plane, an angle (16) formed between the first longitudinal axis (9) of the first conveying section (8) of the conveying device (6) and the further longitudinal axis (13) of the further conveying section (14) of the extruder screw (11) is an obtuse angle.

19. The processing plant (1) as claimed in claim 13, wherein the first longitudinal axis (9) in the region of the first conveying section (8) of the conveying device (6) and the further longitudinal axis (13) in the region of the further conveying section (14) of the at least one extruder screw (11) are respectively arranged running in a horizontal plane.

20. The processing plant (1) as claimed in claim 13, wherein the first longitudinal axis (9) in the region of the first conveying section (8) of the conveying device (6), viewed in its direction of conveyance, is oriented such that it slopes down toward at least one extruder screw (11) of the plasticizing device (3).

21. The processing plant (1) as claimed in claim 13, wherein the spirally configured conveying device (6) has a right-hand pitch and the at least one extruder screw (11) likewise a right-hand pitch, and both the conveying device (6) and the extruder screw (11), respectively viewed in the direction of conveyance thereof, are driven counterclockwise.

22. The processing plant (1) as claimed in claim 13, wherein the spirally configured conveying device (6) has a left-hand pitch and the at least one extruder screw (11) likewise a left-hand pitch, and both the conveying device (6) and the extruder screw (11), respectively viewed in the direction of conveyance thereof, are driven clockwise.

23. The processing plant (1) as claimed in claim 13, wherein the spirally configured conveying device (6) has a right-hand pitch and the at least one extruder screw (11) a left-hand pitch, and the conveying device (6), viewed in its direction of conveyance, is driven counterclockwise, and the extruder screw (11), viewed in its direction of conveyance, clockwise.

24. The processing plant (1) as claimed in claim 13, wherein the spirally configured conveying device (6) has a left-hand pitch and the at least one extruder screw (11) a right-hand pitch, and the conveying device (6), viewed in its direction of conveyance, is driven clockwise, and the extruder screw (11), viewed in its direction of conveyance, counterclockwise.
